(19) United States
(12) Patent Application Publication
(10) Pub. No.: US 2008/0205295 A1
(43) Pub. Date: Aug. 28, 2008

(54) Creation of organizational hierarchies in a group-centric network via handshake mechanisms

(75) Inventor: Nelson Saba, Gotha, FL (US)

Correspondence Address: CARR & FERRELL LLP, 2200 GENG ROAD, PALO ALTO, CA, 94303, US

(73) Assignee: Lights Together LLC

(21) Appl. No.: 11/728,218

(22) Filed: Mar. 23, 2007

Related U.S. Application Data
(60) Provisional application No. 60/899,092, filed on Feb. 2, 2007.

(51) Int. Cl. H04L 12/28

(52) U.S. Cl. 370/254

(57) ABSTRACT

Exemplary systems and methods for creating organizational hierarchies in a group-centric network are provided. In exemplary embodiments, a request to establish a new group within an organization on the group-centric network is received by the group-centric network host. The group-centric network host then determines if the request if from an authorized individual, such as a leader of a home group representing the organization. If the request is not from an authorized individual, at least one message-based handshake through which one or more relationships of the new group may be activated is performed.

### CROSS-REFERENCE TO RELATED APPLICATIONS

The present application claims benefit of U.S. Provisional Patent Application No. 60/899,092 filed Feb. 2, 2007 and entitled “Group-Centric Social Network,” which is hereby incorporated by reference.

### BACKGROUND

1. Field of the Invention

Embodiments of the present invention are direct to networking and more particularly to creation of organizational hierarchies in a network.

2. Related Art

Presently, users may utilize social networks to communicate with others socially. These social networks are typically a collection of individuals accessing a single social network host, and typically representing both a collection of ties between people and the strength of those ties. In some embodiments, the social network is a map of relationships between individuals, which indicate ways in which individuals are connected through various social familiarities ranging from casual acquaintance to close familial bonds, for example.

Typically, each individual within the social network has their own web page on which any information the individual desires to present may be posted. Some information on the web page may be private, such that only those with relationships with the individual can view the private information. Other information may be public, such that any member of the social network may be able to view the public information.

Often times, the relationships are created between two individuals via an invitation from one individual to another. In some embodiments, a request to establish a relationship may also be utilized to create the relationship.

Networks of generic organization may also be present on the Internet. However, there are no networks which allow these organizations to be represented as a hierarchical organization of groups. Therefore, there is a need for such a group-centric network.

### SUMMARY OF THE INVENTION

Embodiments of the present invention provide systems and methods for creating organizational hierarchies in a group-centric network. In exemplary embodiments, a request to establish a new group within an organization established on the group-centric network is received by the group-centric network host.

The group-centric network host then determines if the request is from an authorized individual. In various embodiments, any member of the organization may be enabled to create a new group. As such, the new group and associated relationships of the new group are inactive until an authorized individual of the organization approves of the new group. In exemplary embodiments, the authorized individual is a leader of a home group, which represents the overall organization on the group-centric network.

If the request is not from an authorized individual, at least one message-based handshake through which one or more relationships of the new group may be activated is performed. The message-based handshake may comprise a message exchange to a leader of the home group to approve of the new group. In some embodiments, the handshake may also comprise a message exchange to a leader of a potential parent group to the new group to authorize a relationship. Further message exchanges may be utilized to establish other relationships such as group membership, group leadership, project leadership, project membership, and so forth.

### BRIEF DESCRIPTION OF THE DRAWINGS

FIG. 1 is a block diagram of an environment in which embodiments of the present invention may be practiced.

FIG. 2 is a block diagram of an exemplary hierarchical structure within one organization of the group-centric network.

FIG. 3 is a block diagram of an exemplary group-centric network host.

FIG. 4 is a block diagram of an exemplary accounts engine.

FIG. 5 is a block diagram of an exemplary messaging engine.

FIG. 6 is a flowchart of an exemplary method for establishing a home group on the group-centric network.

FIG. 7 is a flowchart of an exemplary method for establishing a child group within an organization on the group-centric network.

FIG. 8 is an example of an organization set-up application.

FIG. 9 is an example of a group set-up application.

FIG. 10 is an example of a group activation handshake message received by an authorized individual.

FIG. 11 is an example of a connection request message to invite an individual to lead a group.

FIG. 12 is an example of an invitation acceptance message received by an individual.

FIG. 13 is an example of a recently established new group web page.

FIG. 14 is an example of a fully populated group web page.

### DETAILED DESCRIPTION OF EXEMPLARY EMBODIMENTS

Embodiments of the present invention provide systems and methods for creating and maintaining a group-centric network. In various embodiments, the group-centric network allows organizations to be represented and made functional over a network, such as the Internet. Groups, projects, and services of each organization may then be coupled through managerial, functional, and business relationships, established within, and according to, an organizational structure. In exemplary embodiments, the organizational structure may be determined by leaders within the organization. According to some embodiments, the group-centric network may comprise a group-centric social network. In alternative embodiments, the group-centric network may comprise a group-centric business or educational network, or any other type of group-centric network.

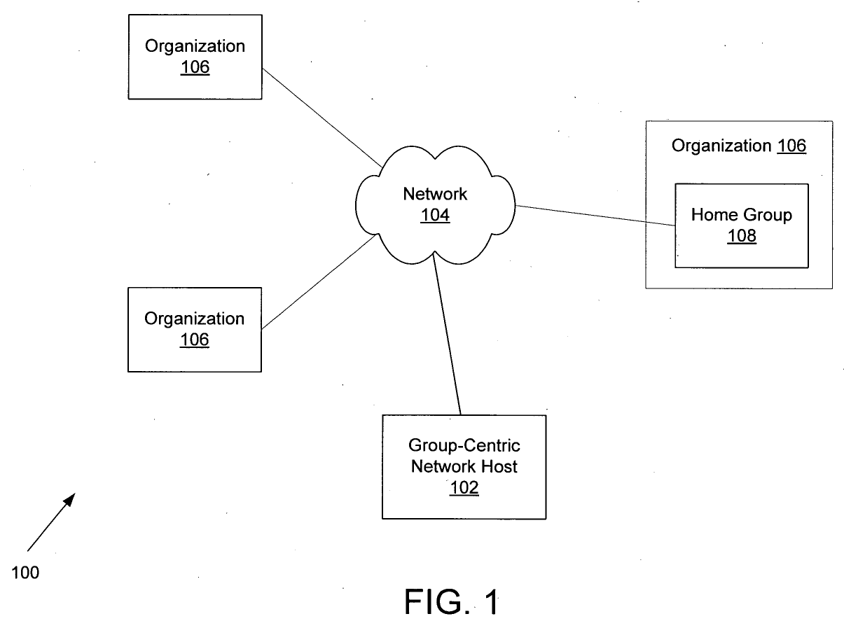

Referring now to FIG. 1, an exemplary environment 100 in which embodiments of the present invention may be practiced is provided. The exemplary environment 100 comprises a group-centric network host 102 coupled via a communications network 104 to a plurality of organizations 106. The communications network 104 may comprises any type of communications network, such as the Internet.

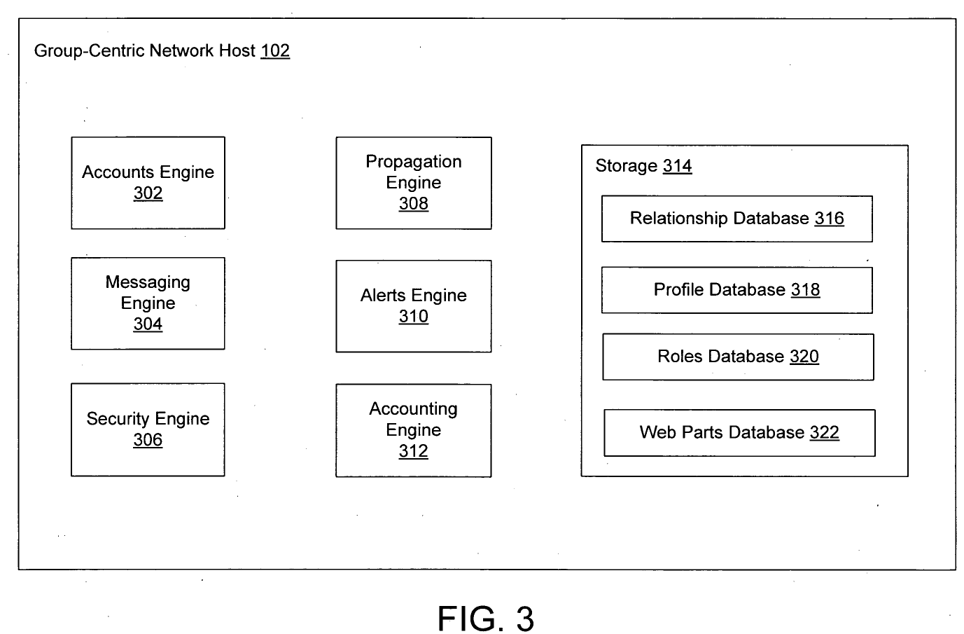

In exemplary embodiments, the group-centric network host 102 comprises one or more servers configured to create and maintain the group-centric network of organizations 106 and groups within organizations 106 using various mechanisms to establish groups and their relationships. These mechanisms may be utilized by organizations, groups, and individuals to set up their presence on the communications network 104. The group-centric network host 102 will be discussed in more details in connection with FIG. 3 below.

The organization 106 represents any entity that desires to establish a presence on the group-centric network. The organization 106 may comprise profit or nonprofit entities. For simplicity of discussion, embodiments of the present invention will be discussed utilizing churches as the organizations 106. However, the organizations 106 may be any type of organizations, such as businesses, franchises, sponsors, universities, retail chains, advertisers, and partners. The sponsors or partners may be organizations 106 which provide goods or services to other organizations 106 on the group-centric network.

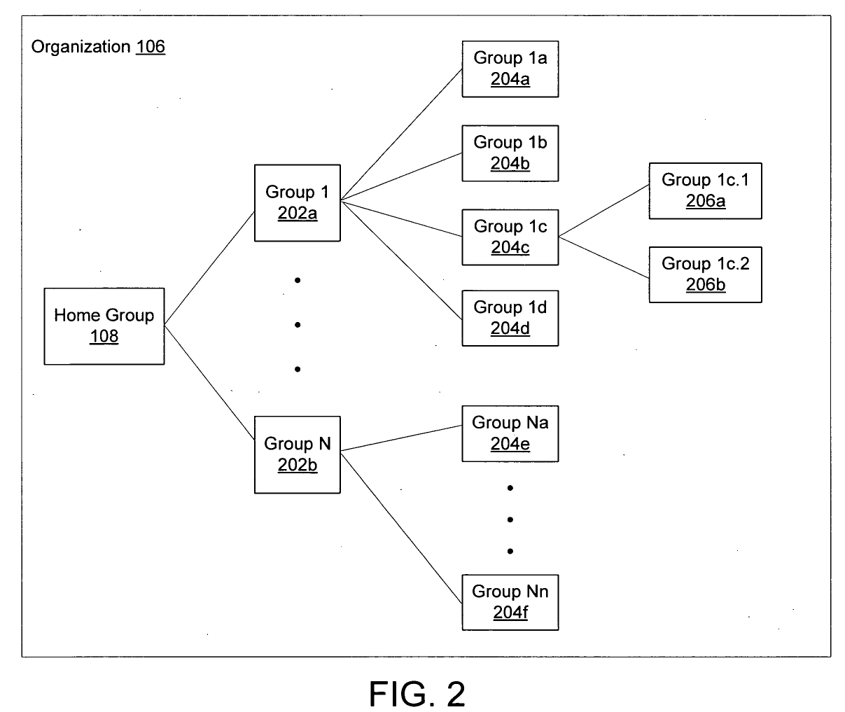

In exemplary embodiments, each organization 106, at a highest level, is represented on the group-centric network as a home group 108. The home group 108 is a highest level group in an organization structure that may be established for the organization 106. Each home group 108, in turn, may be linked to one or more subgroups. These subgroups are termed “child groups” of the home group 108 as they are spawns off of the home group 108 or “parent group.” An example of this organizational structure will be discussed in connection with FIG. 2.

FIG. 1 illustrates one exemplary embodiment of the environment 100 in which embodiments of the present invention may be practiced. Alternative embodiments may comprise any number of organizations 106 coupled to any type of communications network 104. Additionally, more than one group-centric network host 102 may be present.

Referring now to FIG. 2, an exemplary organizational structure for the organization 106 is shown. The overall organization 106 is represented on the group-centric network as the home group 108. The home group 108 may comprises (e.g., be linked to) one or more child groups. In FIG. 2, the home group 108 is shown directly coupled to a plurality of child groups (group 1 202a through group N 202b). Any number of these first level child groups 202 may be coupled to the home group 108. For example, if the home group 108 represents Wood River Church on the group-centric network, then child group 1 202 a may represent Small Groups Ministry of the Wood River Church.

Furthermore, each first level child group 202 may be coupled to one or more second level child groups. As shown, child group 1 202a comprises a plurality of second level child groups (e.g., group 1a 204a through group 1d 204d). Similarly, child group N 202b is coupled to a plurality of second level child groups (group Na 204e through group Nn 204f). Any number of second level child groups 204 may be established and coupled to the first level child group 202. As a result, the first level child group 202 becomes a parent to the second level child group 204. Alternatively, the first level child group 202 may not be coupled to any second level child groups 204.

Continuing with the example, the Small Groups Ministry may comprise a plurality of small ministry groups, each small ministry group comprising at least one leader and one or more members. These small ministry groups may be referred to as child groups of the Small Group Ministry, which is a parent to the small group.

As further shown, the second level child group 204, itself, may be a parent to third level child groups 206. The organizational structure allows any number of levels of child groups to be established within a single organization 106. Additionally, any number of parent-child relationships may be established within the organizational structure represented on the network 104 with any specific child group having one parent.

Each group within the organization 106 (e.g., home group 108, child groups 202-206) may be defined by its profiles, functions, relationships, and members. The profile comprises basic group information which is provided upon group creation. The group information may include, for example, characteristics, purpose, identification of a group leader, and contact information for the group leader.

The functions comprise a collection of special functionality components that reflect communication, coordination, and functional needs of the group 108 and 202-206. In exemplary embodiments, the functionality components utilizes web parts components, as will be discussed in more detail in connection with FIG. 3. Each group's profile and catalog of functions are defined based on a group and relationship type (e.g., parent or child) and reflects the group's purpose.

Each organization 106 may be represented on the group-centric network as an organizational structure comprising groups 108 and 202-206 and individuals networked together through various relationships. These relationships establish how the group 108, 202, 204, or 206 is connected within the organizational structure to other groups 108 and 202-206 and individuals. Exemplary relationships may comprise line relationships, lateral relationships, staff relationships, functional relationships, group membership relationships, and individual membership relationships. The line relationship comprises a direct parent-child relationship between two groups 108, 202, 204, or 206 in the organizational structure, for example, as shown in FIG. 2. For example, there is a parent-child relationship between the home group 108 and first level child group 1 202a.

The lateral relationship comprises a relationship between groups on the same hierarchical level. In the example of FIG. 2, there is a lateral relationship between child group 1 202a and child group N 202b.

The staff relationship comprises a relationship between, for example, an administrative group and other groups 108, 202, 204, or 206 for advisory purposes. For example, an information technology group may form relationships with a plurality of child groups 202-206 in order to provide technical assistance.

The functional relationship may comprise a relationship between a special purpose group and other groups 108, 202, 204, or 206. In some embodiments, this relationship comprises a line relationship that relates to the special function of the group. These groups may have a special purpose and therefore a limited set of functions the group can perform, which would be reflected in an actual set of webparts available for the group. For example, an ec-ommerce group, such as a church store, may be a special function group in the organization 106.

The group membership relationship comprises a relationship that establishes that a group belongs to an organizational structure. This relationship is, in some embodiments, established with the home group 108 of the organization 106. In other embodiments, membership may be between two independent organizations 106 (each one with its own home group), wherein one organization 106 is a member of the other organization 106. An example of this comprises a church denomination and its churches. Both are organization 106 having independent group hierarchies with their own home groups 108. However, there is a membership relationship between the home group 108 of each church (e.g., organization 106) of that denomination and an organization 106 of the church denomination hierarchy. A specific example comprises the Orlando Church of the Nazarene, which is a member of the Nazarene Denomination through a relationship of the Orlando Nazarene Church home group with the group “South East Region” of the Nazarene Denomination hierarchy.

The individual membership relationship comprises relationships established between an individual and the group 108, 202, 204, or 206 making that individual a member of that group 108, 202, 204, or 206. Members comprise individuals that participate in the group 108, 202, 204, or 206 in different roles. The roles may comprise leaders, project managers, general members, administrators, and so forth.

Furthermore, there may be two categories of relationships: within the organization 106 and outside of the organization 106. Within the organization, there are relationships between groups 108 and 202-206 (e.g., parent and child) and individual relationships (e.g., member, leaders) as previously discussed. Outside of the organization 106, relationships may be established between different organizations 106 (e.g., sponsorship, partnership, etc.). In some embodiments, the establishment of relationships may be based on criteria. For example, if a sponsor is looking to sponsor Baptist churches within a 20 mile radius, then a church (i.e., organization 106) fitting these criteria may establish a relationship with this sponsor.

In exemplary embodiments, the child groups 202, 204, and 206 may be inactive until the home group 108 approves of their establishment. In exemplary embodiments of the present invention, the relationships between groups 108 and 202-206 are established via message-based handshakes. In various embodiments, these child groups require approval by an authorized individual associated with the home group 108 (e.g., leader of the home group 108) before the child group being create and its associated relationships are activated. In some embodiments, any group 202-206 not the home group 108 is inactive until it either becomes a home group 108, itself, or establishes a relationship with another group that either has a home group 108 linked to it or is a home group 108.

The message-based handshake mechanisms used to establish the relationships may be provided in an automatic manner. For example, as soon as the child group 202-206 is created, an approval message request to a leader of the home group 108 is generated. In some embodiments, the approval message request may be automatically generated (e.g., an e-mail template with information fields already populated is presented). In an alternative embodiment, the approval message request may be manually generated. For example, a creator of the child group 202-206 may compose and send a message to the authorized individual associated with the home group 108 asking for approval.

Once approved and activated, each child group 202-206, as well as the home group 108, may be represented on the group-centric network by one or more group web pages. These web pages may reflect the group's profile, functions, relationships, leadership, and members. As such, the web pages may be customized for each group 108 and 202-206. The customization of the web pages will be discussed in more detail in connection with the web parts discussion in FIG. 3.

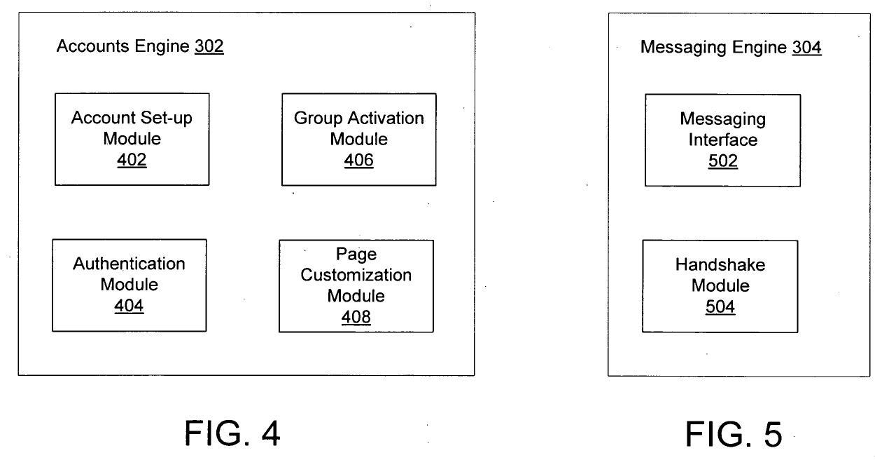

Referring now to FIG. 3, the group-centric network host 102 is shown in more detail. In exemplary embodiments, the group-centric network host 102 comprises an accounts engine 302, a messaging engine 304, a security engine 306, a propagation engine 308, an alerts engine 310, an accounting engine 312, and storage 314. The exemplary accounts engine 302 is configured to manage individuals, groups, and organizations 106 on the group-centric network, and will be discussed in more detail in connection with FIG. 4.

The exemplary messaging engine 304 is configured to provide mechanisms to communicate within the network 104 including providing handshake mechanisms for establishing relationships between groups 104 and 202-206. The messaging engine 304 will be discussed in more detail in connection with FIG. 5.

In exemplary embodiments, the security engine 306 may restrict an individual's access within the organization 108 based on their roles and relationships in the organization 106 and privacy settings of the data. For example, some data posted on a group's web page may be made private. This private data may only be accessed by, for example, group leaders. In some embodiments, the access for each piece of data may be set in a profile for the data which is established when the data is posted to the web page. In various embodiments, there are three levels of access: public (e.g., anyone can view), members (e.g., must be a member to view), and leaders (e.g., only leaders can view). The security engine 306 will determine based on these levels of access whether an individual accessing the data is permitted to view the data.

In another example, the security engine 306 may restrict an individual's functions based on their role in the organization 106. In exemplary embodiments, functions related to the group's web pages may be limited based on privacy settings. The privacy settings may comprise leaders, members, administrator, and public. For example, a general member of a group may not be permitted to change the group's web page, but only be allowed to view its content.

In various embodiments, individuals (e.g., group members) may create their own web pages within the organization 106 as well. The data on these web pages may also apply privacy settings. For example, private data may only be accessed by leaders of the groups the individual is a member of, while public data may be accessed by the public at large. A “friends” setting may also be utilized to allow fellow group members to access the data, according to some embodiments.

The exemplary propagation engine 308 is configured to propagate data within the organization 106. For example, if a child group has a posting of new events, the new events may be propagated up to the parent group of this child group. As a result, a page of the parent group may show the new event on their events calendar. In some embodiments, propagation of data occurs if a profile of the data allows for it. For example, if the data is specific only to a particular group, then the data may not be allowed to propagate the data up to the next level (e.g., the parent group). In some embodiments, data may be propagated down as well (e.g., from a parent group to child groups) and displayed on the child group pages.

In exemplary embodiments, the alerts engine 310 is configured to provide alerts to an individual based on settings set by the individual, for example, in their profile. As such, the alerts engine 310 monitors data within the organization 106 to determine if new data has been posted. If new data is posted, the alerts engine 310 determines if any individuals have requested an alert for that new data. For example, when a member logs into their web page, an alert for new events (for groups that the member is a member of) may be provided. Alerts may also be provided for news, blogs, and other information.

The exemplary accounting engine 312 is configured to maintain accounting and billing information for each organization 106. In various embodiments, each organization 106 via the home group 108 subscribes to a particular level of service with the group-centric network host 102. The level of service may determine a certain number of megabytes of storage and bandwidth on the network 104 and types of features available to the groups of the organization 106, for example.

The storage 314 is configured to store various databases associated with the organizations 106, home groups 108, and child groups 202-206. In exemplary embodiments, the storage 314 comprises a relationship database 316, a profile database 318, a roles database 320, and a web parts database 322. These databases 316-322 are exemplary and alternative embodiments may comprise more or less databases or combine some of the databases 316-322 together. For example, other databases may provide layouts and themes, or store events, news, and blogs.

The exemplary relationship database 316 may comprise tables storing relationships between the various organizations and groups within the network 104. Such relationships may include, but are not limited to, parent-child relationships, sponsor-organization relationships, partner-organization relationships, and advertise-organization relationships.

The exemplary profile database 318 may store profile information for each organization 106, group 108 and 202-206, and individuals. Profile information may comprise name, contact information, security settings, preferences, attributes, history, and so forth.

The roles database 320 may, in some embodiments, store an individual's roles (e.g., responsibilities and permissions within a group). These roles may, in one embodiment, be based on relationships between individuals and the home group 108 and/or child groups 202-206. These relationships may, for example, identify the individual as a manager or leader of the group 108 or 202-206 (e.g., power over functions performed within the group and has access to all information handled by the group), officer or member (e.g., has limited powers to perform functions and access information as defined by the group manager), administrator (e.g., responsible for technical and administrative maintenance of the group), a friend (e.g., not a member buy a known individual associated with the group), or a guest (e.g., public which may be registered or unregistered with the group-centric network host 102). As a result, the role of the individual determines access and functionalities enabled for the individual within the group and/or organization 106.

In exemplary embodiments, the web parts database 322 comprises components that are provided to customize a web page. Icons representing these web parts may be shown, for example, on a pop-up window or on a side of a group's web page. The individual (e.g., group leader, creator, or IT staffer) may drag and drop an appropriate icon onto a location of the web page where the selected component should appear in order to customize the web page. In some embodiments, the web parts components also enable functions on the web pages.

For example, when a child group 202-206 is activated on the network 104, the web page for the child group 202-206 is preloaded with a default set of web parts. A leader of the child group 202-206 may change the web page by, for example, accessing the web parts database 322 and dragging and dropping icons representing components such as an event component (e.g., enables events to be posted on a calendar), news component (e.g., allows news to be posted on the page), media components (e.g., allow media, photos, etc. to be posted), and so forth. These web parts components may also allow a leader or administrator to define how information is propagated up, alerts are set, and notifications sent. Once web parts components are dropped on the web page(s), then, according to some embodiments, information may be provided or uploaded to fill in blank templates generated by the web part components.

In some embodiments, the dragged and dropped web parts components or data used to populate the components may be customized to select which of the groups underneath the present group (e.g., a group's child groups) may be featured on the group's site. This results in propagation up of events, news, or other information from the child groups to the present group. For example, if a new event is posted in child group 1a 204a, this new event information may propagate up to a web page of group 1 202a.

Exemplary individual web parts include my friends, my blogs, new activities, my groups, more about me, my projects, things I like, my latest blogs, and past projects, for example. These web parts may be used to customize an member's individual web pages.

Exemplary group and project web parts may include, for example, our projects, our people, our groups, calendar of events, our leaders, our blogs, our parent, and our latest blog. Further embodiments may contemplate other web parts such as our service opportunities, our partner groups, news, video, audio, photos, and webcasts.

Referring now to FIG. 4, the accounts engine 302 is shown in more details. The accounts engine 302 is configured to manage groups on the network 104 by setting up and maintaining data for each account (e.g., individual, group, and organization 106) on the network 104. The accounts engine 302 may comprise an account set-up module 402, an authentication module 404, a group activation module 406, and a page customization module 408.

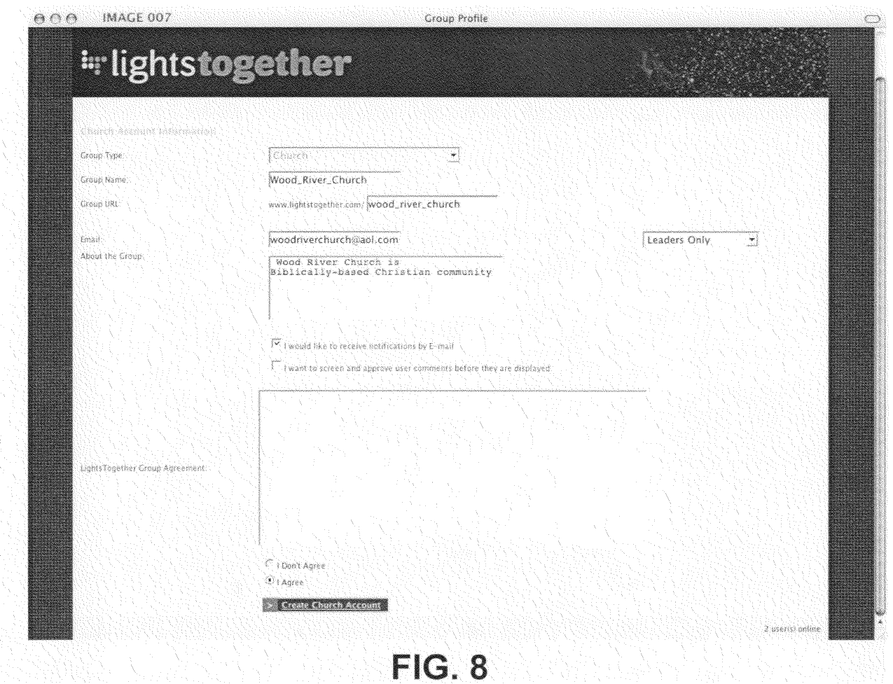

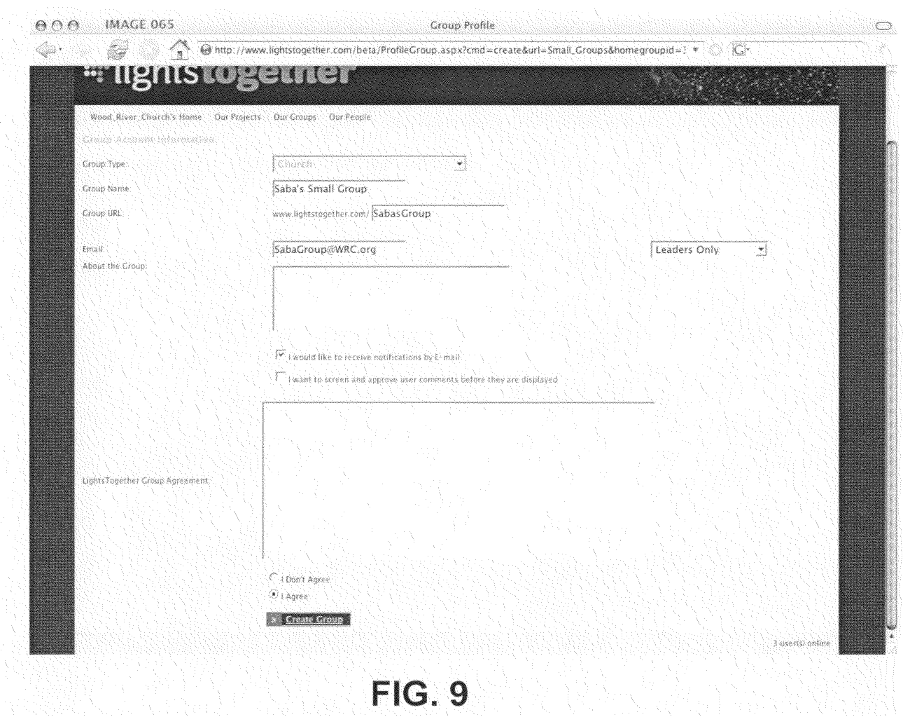

The exemplary account set-up module 402 is configured to provide a graphical interface which is utilized to obtain information needed to establish an account with the group-centric network. The account may be for an individual, a group, or a home group 108. In exemplary embodiments, the graphical interface provides a plurality of fields where an individual or group creator enters information including profile and relationship information. With regards to a home group account, billing and service plan information for the organization 106 is also received by the account set-up module. Examples of these graphical interfaces are shown in FIG. 8 and FIG. 9.

The authentication module 404 authenticates individuals accessing the network 104. In some embodiments, the authentication module 404 will verify user names and passwords of individuals accessing web pages of the organization 106 and/or groups 202-206 by comparing an entered user name and password with one stored in the profile database 318. Once authenticated, the individual may, in some embodiments, access data and perform actions based on their roles (as determined by their profile and relationships) within the organization 106.

When the child group (e.g., child group 1a 204a) account is initially created, the child group 204a is initially inactive until the associated home group 108 approves of the child group 204a. This approval process insures that the home group 108, which is paying for the group-centric network service provided by the group-centric network host 102, has control over use of resources subscribed to by the organization 106. As such, the group activation module 406 is configured to process the approval process.

In further embodiments, relationships of the child group 204a within the organization 106 may also be inactive until corresponding groups within the organization 106 approve a relationship request from the child group 204a. For example, second level group 1a 204a may be created by a member which wants to establish a relationship or link with group 1 202a being a parent to the new group 204a. Thus, a group parent request handshake is performed whereby a group parent request message is sent to an authorized individual (e.g., group leader) for group 1 202a.

In exemplary embodiments, the group activation module 406 will initiate the approval process by triggering the messaging engine 304 to perform a message-based handshake between the new child group 202a (e.g., between the creator of the new child group 202a) and the authorized individual associated with the home group 108 and/or other level group for establishing a relationship. The handshake process will be discussed in detail in connection with FIG. 5. Once the home group 108 (e.g., a leader of the home group 108) approves the child group 202a, then the creator and/or leader of the child group 202a is notified and is enabled to customize a web page for the child group 202a. In some embodiments, the group activation module 406 provides a default web page which may be customized.

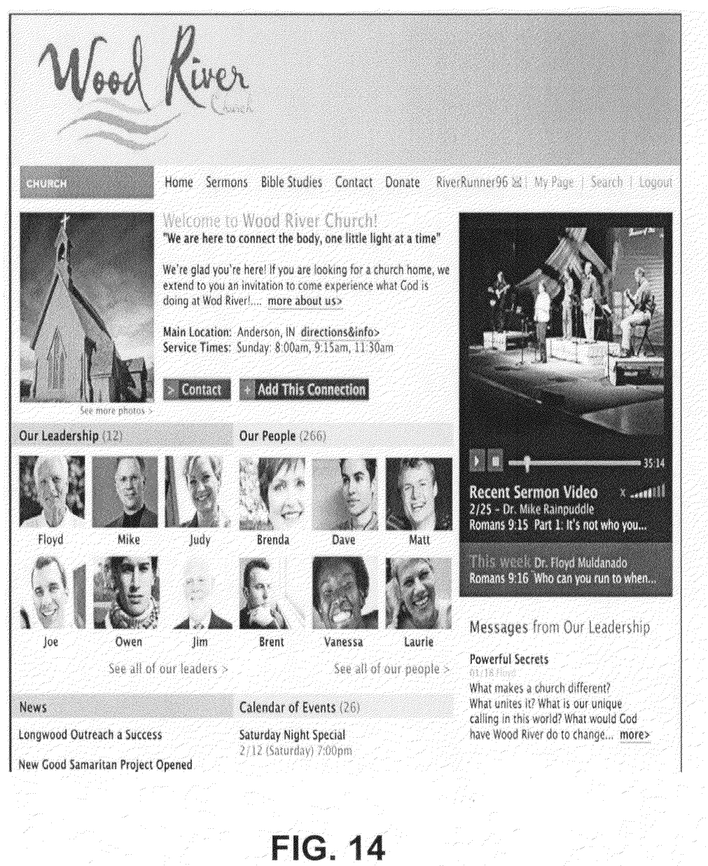

The exemplary page customization module 408 is configured to allow the creator or leader of the child group 202a to customize the group's web page. In exemplary embodiments, a default web page is initially associated with the group. Web parts components may, in some embodiments, be used to customize the web page, as described above. The page customization module 408 provides access to these web parts components in the web parts database 322. The page customization module 408 may also allow the individual to provide or input data to fill their web page. Web page customization will be discussed in more detail in connection with FIG. 13 and FIG. 14.

Referring to now to FIG. 5, the exemplary messaging engine 304 is shown. The messaging engine is configured to enable communications within the organization 106 and between organizations 106. In various embodiments, the messaging engine 304 provides communications (e.g., e-mails) between groups within the organization 106. These communications may include message-based handshakes. Handshakes comprise message exchanges and may be used, in some embodiments, to establish relationships between the groups and individuals which results in creating the organizational structure, such as the organizational structure shown in FIG. 2. The handshakes may also be used to establish relationships between different organizations 106 in the group-centric network and establish relationships with individuals in the organization (e.g., invite leaders and members to join etc.).

The messaging engine 304 may comprise a messaging interface 502 and a handshake module 504. Alternative embodiments may comprise other modules, such as a criteria-based module for use in matching criteria in establishing a relationship between groups.

The exemplary messaging interface 502 is configured to provide a graphical interface through which a handshake mechanism (e.g., an e-mail) may be composed and sent. In various embodiments, the messaging interface 502 may display a template for a particular handshake type. The template may comprise fields in which the individual provides information. In other embodiments, the template may comprise default fields which the individual may change before sending.

In some embodiments, the type of handshake or template provided may be automatically determined by the handshake module 504. For example, upon completion of setup for a new child group, the handshake module 504 may automatically generate an approval request handshake to be sent to the home group 108.

In other embodiments, the individual may select the handshake type or template. For example, a drop down menu or listing of handshake types on a side of a web page may be presented to the individual by the handshake module 504. The individual may then select one of the handshake types and either use the default template or fill in fields on the template.

There are different handshake types for each possible combination of roles and relationships within the network 104. For example, a specific handshake may be utilized for a group manager/leader to invite a group member to become a leader (e.g., group leader invitation). Furthermore, there may be another specific handshake to request approval/activation of the child group (e.g., group parent request) which may be sent to a parent group. Other handshake may comprise partnership handshakes, sponsorship handshakes, membership handshakes (e.g., group join request and group join invitation), or handshakes to establish any other type of relationship available on the group-centric network. The handshake may comprise an invitation handshake, which invites an individual to agree to the relationship (e.g., project join invitation, project leader invitation, etc.). Furthermore, the handshake may comprise a request handshake, which provides a request to establish a relationship (e.g., project join request, group friend request, project friend request, project leader request, group sponsor request, etc.). In yet further embodiments, handshakes may comprise abandon handshakes, such as group member abandon, project member abandon, and group home abandon, for example. In various embodiments, a response to a handshake may comprise a yes, a no, or a more information request.

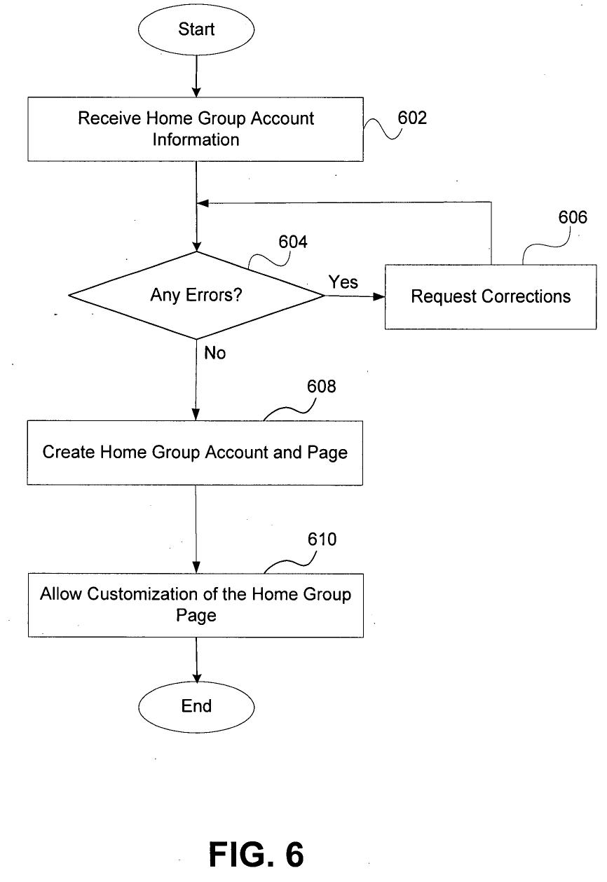

Referring now to FIG. 6, a flowchart 600 of an exemplary method for establishing the home group 108 on the network 104 is provided. In step 602, home group account information is received by the group-centric network host 102. In exemplary embodiments, an individual desiring to establish their organization 106 on the network 104 may access a web page associated with the group-centric network host 102. An online application for establishing the organization 106 on the network 102 may be provided to the individual by, for example, the account set-up module 402. FIG. 8 illustrates one example of the online application provided for account set-up of an organization 106. The individual then provides information regarding the organization 106 required to establish the home group 108. The information may include, for example, name and address of the organization 106, leader/manager of the organization, contact information for the leader/manager, selection of a service plan, and payment information (e.g., credit card billing information).

The account set-up module 402 then determines if there are any errors on the application in step 604. If there is an error, then a request for correction is returned in step 606. For example, if a field in the application may not filled in or filled in incorrectly, then the request is returned.

If all required information is received, then in step 608, a home group account and corresponding web page is created. The home group account information may be stored in the storage 314. Because the home group 108 does not need to be approved, the home group 108 is automatically activated by the group activation module 406. In exemplary embodiments, a default home group web page is provided by the group activation module 406.

In step 610, the default home group web page may be customized. According to some embodiments, web parts components may be added or replace default components on the web page. The leader/manager may then provide, upload, or input data into fields on the various fields on the web page.

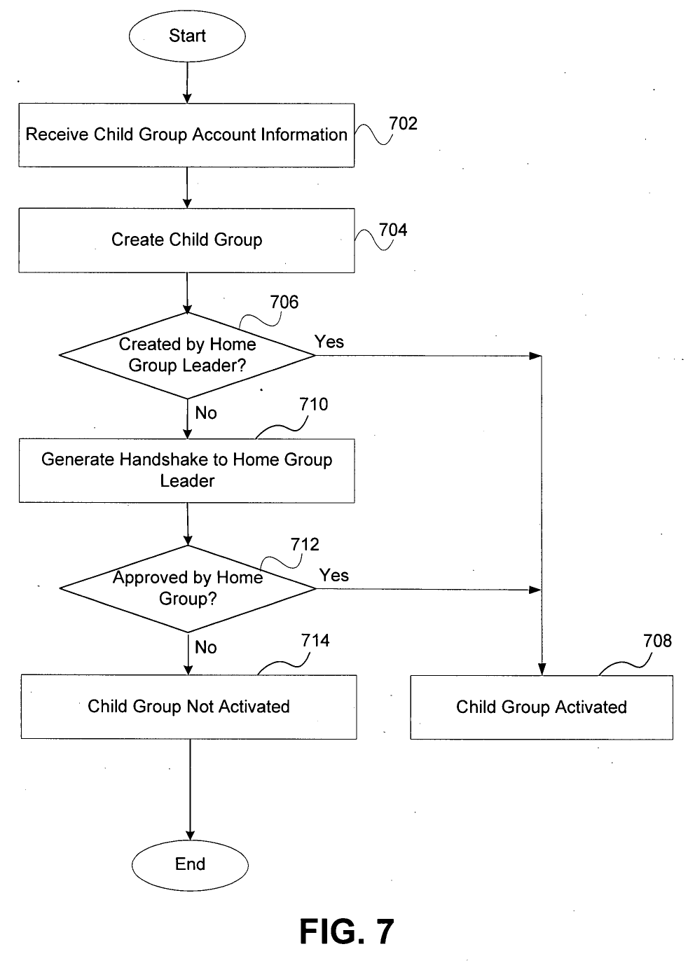

Referring now to FIG. 7, a flowchart 700 of an exemplary method for establishing a child group within the organization 106 is shown. In step 702, child group account information is received by the group-centric network host 102. In exemplary embodiments, an individual desiring to establish a child group accesses an online application associated with the group-centric network host 102. In some embodiments, the individual may access the online application while visiting the web pages of the organization 106 in which the child group is desired. For example, while viewing a web page of the home group 108, the individual may select an icon located on the web page that then provides the online application.

The online application for establishing the child group within the organization 106 may be provided to the individual by, for example, the account set-up module 402. The individual then provides information to establish the child group. The information may include, for example, creator of the child group, leader/manager of the organization, contact information for the leader/manager, and identification of the associated home and/or parent groups. FIG. 9 illustrates one example of a group account set up application.

In step 704, the child group is established. However, in exemplary embodiments, the child group and the associated relationship with the home and/or parent groups are inactive. As previously discussed, a leader of the home group or a person authorized by the home group must, in exemplary embodiments, approve the child group before the child group is activated. Similarly, a relationship with a parent group may need to be approved before the relationship is activated.

If the child group is created by a leader (or authorized individual) of the home group as determined in step 706, then the child group is activated in step 708. In some embodiments, the activation may be automatic upon creation of the child group in step 704. In other embodiments, the creator (e.g., leader of the home group 108) may affirmatively indicate to the group-centric network host 102 that the child group is approved. For example, the creator may be presented with a request to approve and activate the child group upon creation of the child group in step 704.

Once activate, default web page(s) may be generated for the child group. Subsequently, the web page may then be customized for the child group.

If the creator of the child group is not a leader or authorized person of the home group 108, then in step 710, a message-based handshake is performed. In exemplary embodiments, a message is generated to the leader (or authorized individual) of the home group 108 for approval of the new group. In some embodiments, a default approval request message is generated. The creator may provide further information, change default fields, and/or approve of the approval request message before sending. The approval request message is then sent to the home group leader or other authorized individual.

In various embodiments, any member of the organization 106 may create a group within the organization 106. For example, the third level group 1c.1 206a as shown in FIG. 2 may be created. While group 1c 204c is identified as the parent of group 1c.1 206a, the home group 108, in exemplary embodiments, must approve of group 1c.1 206a the group 1c.1 206a is activated. Thus, the approval request handshake is performed.

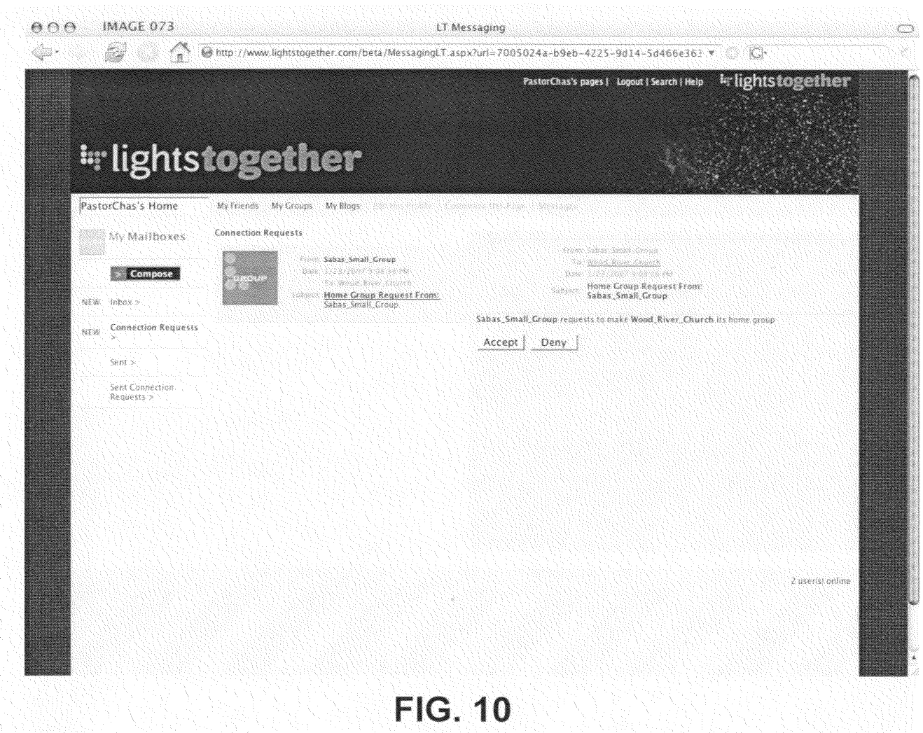

Referring to FIG. 10, the home group leader or authorized individual may receive a connection request handshake message. The message will identify the new group being created and request approval from the home group 108 to activate the new group.

Additionally, another handshake may be performed with group 1c 204c. In this handshake, a handshake message is generated requesting group 1c 204c accept being the parent to group 1c.1 206a. This group parent handshake message may be directed to the leader of group 1c 204c. In some embodiments, the leader of the group 1c 204c must respond with approval to this group parent handshake message in order to activate the relationship between the two groups 204c and 206a. In exemplary embodiments, this handshake may only need to be performed if the leader (or authorized individual) of the parent group did not create the child group.

If the home group leader approves the child group in step 712, then the child group and associated relationship is activated in step 708. However, if the home group leader does not approve of the child group, then the child group remains inactive. In some embodiments the creator of the child group is notified and/or the child group is removed from the organization 106.

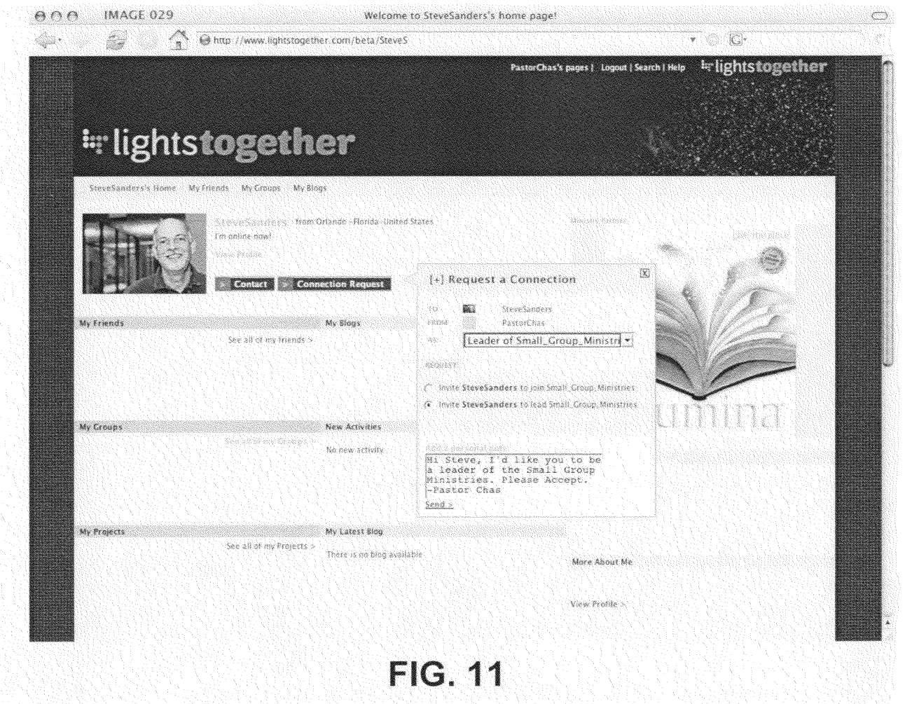

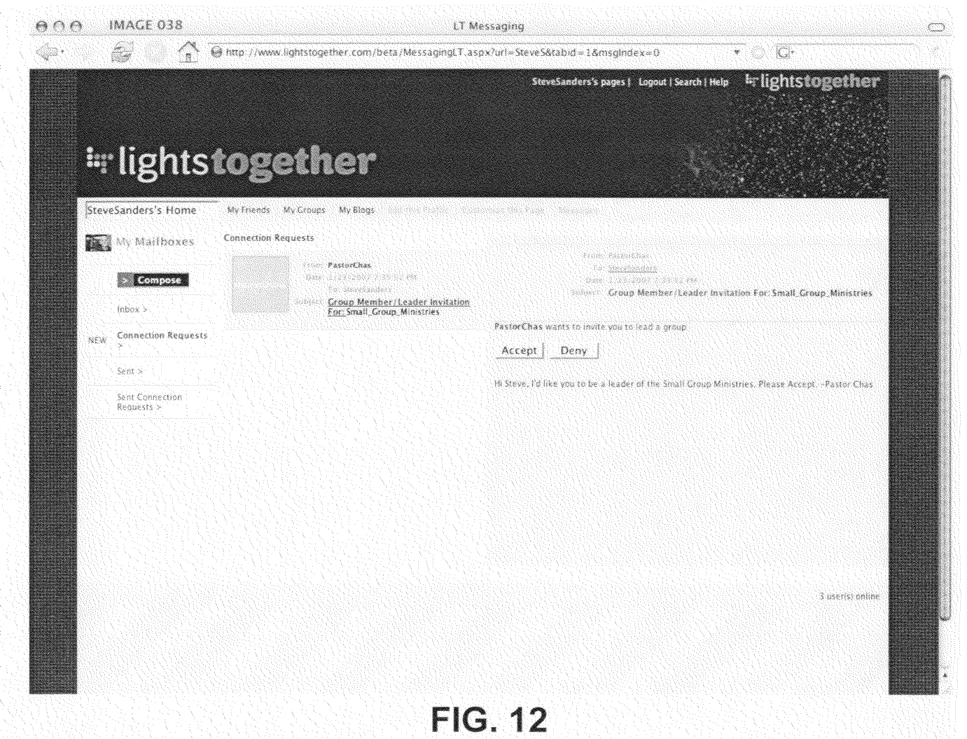

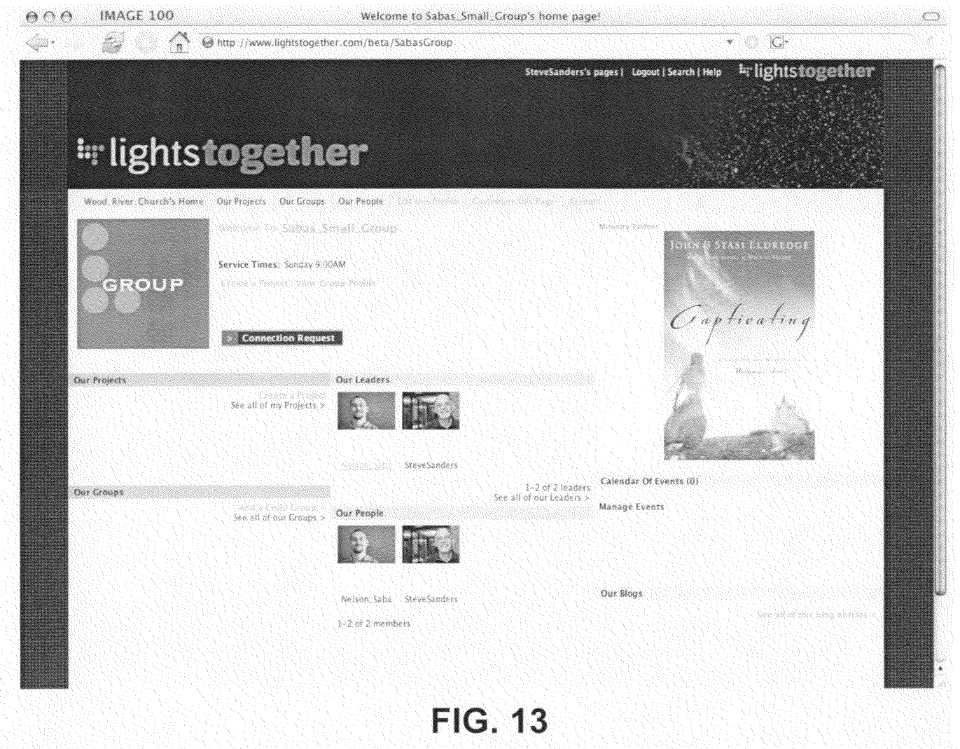

A further handshake may be performed to invite members or leaders for the new group. Referring to FIG. 11, an example of a connection request to invite an individual to lead a group is shown. As shown, the handshake may comprise a message including a personal note section. The message is then sent to the invited individual, who will have the option to accept or deny the request via an invitation acceptance message as shown in FIG. 12.

FIG. 13 shows an exemplary web page for a group of an organization 106. The web page comprises a plurality of exemplary web part components including our projects, our group, our leaders, our people, calendar of events, and our blogs components. In various embodiments, some of these components are blank until a member or leader populates the web part components with information. Other web part components may be populated automatically when requests are accepted. For example, the our leaders and our people components may be automatically populated as soon as the individuals accepts a leadership or member role in the group.

FIG. 14 illustrates a fully populated group web page. The exemplary web page is associated with a home group 108. It should be noted that the example web pages of FIG. 13 and FIG. 14 are exemplary and that alternative embodiments may comprise web pages having different combinations of web part components.

The above-described functions and components can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with embodiments of the present invention. Those skilled in the art are familiar with instructions, processor(s), and storage medium.

The present invention has been described above with reference to exemplary embodiments. It will be apparent to those skilled in the art that various modifications may be made and other embodiments can be used without departing from the broader scope of the invention. Therefore, these and other variations upon the exemplary embodiments are intended to be covered by the present invention.

What is claimed is:

1. A method for creating organizational hierarchies in an organization of a group-centric network, comprising:
receiving a request to establish a new group within the organization on the group-centric network;
determining if the request is from an authorized individual of the organization; and
if the request is not from an authorized individual of the organization, performing at least one message-based handshake through which one or more relationships of the new group may be activated.

2. The method of claim 1 further comprising, if the request is from an authorized individual, activating the new group.

3. The method of claim 1 wherein the authorized individual comprises a leader of a home group of the organization.

4. The method of claim 1 wherein performing the at least one message-based handshake comprises providing an approval request message to the authorized individual.

5. The method of claim 1 wherein performing the at least one message-based handshake comprises providing a group parent request message to an individual associated with a potential parent group to the new group.

6. The method of claim 1 wherein performing the at least one message-based handshake comprises receiving a response to a message.

7. The method of claim 6 further comprising determining based on the response whether to activate the one or more relationships.

8. The method of claim 1 further comprising activating the new group based on a response associated with the at least one message-based handshake.

9. The method of claim 1 further comprising performing a message-based handshake to establish individual relationships with the new group.

10. The method of claim 9 wherein the message-based handshake comprises a leader or member invitation.

11. The method of claim 9 wherein the message-based handshake comprises a leader or member request.

12. A system for creating organizational hierarchies in an organization of a group-centric network, comprising:
an account set-up module configured to receive account set-up data for establishing a new group within the organization on the group-centric network;
a group activation module configured to determine whether to activate one or more relationships of the new group; and
a messaging engine configured to performing at least one message-based handshake to activate the one or more relationships of the new group.

13. The system of claim 1 further comprising a page customization module configured to allow customization of a web page associated with the new group.

14. The system of claim 1 further comprising a storage configured to store data associated with the new group.

15. The system of claim 1 further comprising a web parts database configured to provide customization tools for customizing a web page associated with the new group.

16. The system of claim 1 wherein the message-based handshake comprises an invitation handshake.

17. The system of claim 1 wherein the message-based handshake comprises a request handshake.

18. A machine readable medium having embodied thereon a program, the program having instructions operable by a machine for creating organizational hierarchies in an organization of a group-centric network, the method comprising:
receiving a request to establish a new group within the organization on the group-centric network;
determining if the request is from an authorized individual of the organization; and
if the request is not from an authorized individual of the organization, performing at least one message-based handshake through which one or more relationships of the new group may be activated.

19. The machine readable medium of claim 18 wherein performing the message-based handshake comprises providing an approval request message to the authorized individual.

20. The machine readable medium of claim 18 wherein performing the message-based handshake comprises providing a group parent request message to an individual associated with a potential parent group to the new group.
